(19) United States
(12) Patent Application Publication
(10) Pub. No.: US 2026/0275991 A1
(43) Pub. Date: Sep. 17, 2026

(54) MAGNETIC ASSEMBLY AND VACUUM PUMP

(71) Applicant: Leybold GmbH, Cologne (DE)

(72) Inventor: Christian Hoesgen, Cologne (DE)

(21) Appl. No.: 19/168,623

(22) PCT Filed: Apr. 16, 2024
(86) PCT No.: PCT/EP2024/060231

§ 371 Date: Sep. 24, 2025

(30) Foreign Application Priority Data
May 17, 2023 (GB) 2307335.6

(51) Int. Cl. F04D 19/04; F04D 25/02; F04D 29/058; F04D 29/64; F16C 32/04

(52) U.S. Cl. CPC F04D 19/042; F04D 25/026; F04D 29/058; F04D 29/644; F16C 32/0427; F16C 2360/45

(57) ABSTRACT

Magnetic assembly for a rotor preferably of a molecular drag vacuum pump, comprising a first rotated magnet to be connected to the rotor and rotated together with the rotor, a static damper element arranged axially next to the first rotated magnet to induce eddy currents into the static damper element, a rotated yoke arranged axially next to the first rotated magnet extending radially, a static coil configured to generate a magnetic field, and a static yoke connected to the static coil and arranged directly next to the rotated yoke to induce an axial magnetic force into the rotated yoke.

### CROSS-REFERENCE OF RELATED APPLICATION

This application is a Section 371 National Stage Application of International Application No. PCT/EP2024/060231, filed Apr. 16, 2024, which is incorporated by reference in its entirety and published as WO 2024/235542 A1 on Nov. 21. 2024, the content of which is hereby incorporated by reference in its entirety and which claims priority of British Application No. GB2307335.6, filed May 17, 2023.

### BACKGROUND

The present invention relates to a magnetic assembly for a rotor of a vacuum pump and preferably of a molecular drag pump. Further, the present invention relates to a vacuum pump comprising such a magnetic assembly. Further, the present invention relates to a method for assembly of such a vacuum pump.

Molecular drag pumps, such as turbomolecular pumps, comprise a housing having an inlet and an outlet. The pump chamber defines a housing and a rotor assembly is rotatably supported within the pump chamber. The rotor assembly comprises a rotor shaft, wherein at least one pump element is connected to the rotor shaft for interacting with at least stator element. The rotor assembly is rotated by an electromotor in order to convey a gaseous medium from the inlet to the outlet. Therein, the rotor assembly may be supported by one or more radial bearings, wherein one or more of these radial bearings can be implemented as passive magnetic bearing comprising permanent magnets in order to support the rotor by their magnetic force.

In particular, when using passive magnetic bearings as radial bearings it might be necessary to have an axial bearing in order to control the axial position of the rotor within the housing. This axial bearing might be implemented as an active axial magnetic bearing. In addition, fast rotating vacuum pumps require a damping element in order to suppress unwanted vibrations or tumbling motions of the rotor. In order to implement the axial bearing as well as the damper a large space is required. Furthermore, in some implementations the axial bearing as well as the damper require rotated permanent magnets. Implementing the required permanent magnets individually for each of the axial bearings as well as the damper increases the costs and complexity of the vacuum pump.

It is an object of the present invention to provide a magnetic assembly for a rotor of vacuum pump and in particular a molecular drag vacuum pump which is compact in size and cost effective to implement.

The discussion above is merely provided for general background information and is not intended to be used as an aid in determining the scope of the claimed subject matter. The claimed subject matter is not limited to implementations that solve any or all disadvantages noted in the background.

### SUMMARY

The object is solved by a magnetic assembly according to claim 1, a vacuum pump according to claim 9 and a method for assembly of a vacuum pump according to claim 10.

According to the present invention, a magnetic assembly for a rotor, preferably of a molecular drag vacuum pump, comprises a first rotated magnet to be connected to and rotated together with the rotor of the vacuum pump. The first rotated magnet may have an axial magnetization. The rotor defines an axial direction which is coincident with the axis of rotation of the rotor. The magnetic assembly comprises a static damper element arranged axially next to the first rotated magnet such that by the first rotated magnet eddy currents are induced in the static damper element. Thus, by the combination of the first rotated magnet acting as damper magnet and the static damper element, an eddy current damper (ECD) is built in order to reduce unwanted motions of the rotor.

Furthermore, a rotated yoke is arranged axially next to the first rotated magnet extending in a radial direction. The magnetic assembly further comprises a static coil configured to generate a variable or dynamic magnetic field. The static coil is connected to a static yoke, wherein the static yoke is arranged directly next to the rotated yoke to apply an axial magnetic force to the rotated yoke for control of the axial position of the rotor. By the variable magnetic field of the coil the magnetic force can be controlled in order to control the axial position of the rotor. In particular, the magnetic assembly and more preferably the magnetic axial bearing comprises only a single static coil in order to reduce the complexity of the magnetic assembly, the space required and consequently also the costs of the magnetic assembly. Due to arrangement of the rotated yoke axially next to the first rotated magnet, the first rotated magnet acts as bias magnet inducing a magnetization into the rotated yoke, wherein the magnetic field of the static coil acts together via the static yoke with the magnetic field of the bias magnet, i. e. the first rotated magnet. Hence, the first rotated magnet has two purposes. First, the first rotated magnet is used in configuration of an ECD as a damper magnet to induce eddy currents into the static damper element and, second, it acts a bias magnet in the axial bearing of the magnetic assembly. Thus, the damper and the axial bearing are combined together, wherein the number of necessary permanent magnets is reduced due to the twin purpose of the first rotated magnet. Thus, costs for additional permanent magnets are omitted and at the same time the required building space is reduced due to a combination of the damper and the axial bearing.

Preferably, the static yoke surrounds the static coil and defines a gap, wherein the rotated yoke extends into the gap. Thus, a magnetic circuit is created via the static yoke, the rotated yoke and the first rotated magnet. At the same time a magnetic circuit is created via the static coil, the static yoke, the rotated yoke and the first rotated magnet. Thus, for the ECD as well as the axial bearing magnetic field either at the static damper element or the rotated yoke are optimized/increased.

Preferably, the static yoke is built by one or more yoke elements, which are assembled together in order to build combinedly the static yoke. Thus, assembly of the static yoke facilitates interlocking elements of the magnetic assembly and subsequent assembly of the static yoke by the one or more yoke elements.

Preferably, the rotated yoke and/or the static yoke are made from a magnetic material such as steel or the like in order to be able to create the magnetic circuit.

Preferably, the static damper element is made of a conductive material to conduct the eddy currents induced by the rotated magnet. More preferably, the static damper element is made from copper.

Preferably, the first rotated magnet comprises a first axial end and an opposite second axial end, wherein the static damper element is arranged directly axially next to the first axial end and the rotated yoke is connected to the second axial end. Hence, the static damper element and the rotated yoke are arranged at opposite axial ends of the first rotated magnet, wherein of course the rotated yoke is directly connected or may be in direct contact with the first rotated magnet (since the rotated yoke itself is rotated as well), wherein the static damper element is only arranged in close proximity to the first rotated magnet and not in contact with the first rotated magnet (since the static damper element is not rotated and contact must be prevented). By this arrangement the rotated yoke as well as the static damper element can be placed in close proximity to the first rotated magnet in order to enhance the magnetic fields at the position of the rotated yoke and/or the static damper element.

Preferably, the magnetic assembly comprises a second rotated magnet. The second rotated magnet may have an axial magnetization, wherein the magnetization is the same as the first rotated magnet. By the second rotated magnet the magnetic fields in the magnetic assembly are increased in order to enhance a damping effect of the ECD implemented by the static damper element and also the efficiency of the axial bearing. Consequently, the combination of the first rotated magnet and the second rotated magnet together act as damper magnets to induce eddy currents into the static damper element and, simultaneously, act together as bias magnets for the axial support of the rotor. Therein, preferably, the second rotated magnet is arranged axially next to the first rotated magnet but spaced apart to create a gap in-between the first rotated magnet and the second rotated magnet. The static damper element may preferably extend into the gap between the first rotated magnet and the second rotated magnet. In this configuration the magnetic field at the static damper element is enhanced and at the same time the static damper element encounters an axial oriented magnetic field.

Preferably, the damper element is L-shaped or T-shaped and comprises an axial part extending in an axial direction, wherein the axial part is radially next to the first rotated magnet and/or the second rotated magnet and a radial part extending in a radial direction, wherein the radial part is arranged axially next to the first rotated magnet and/or the second rotated magnet, i. e. in the gap created between the first rotated magnet and the second rotated magnet. Thus, eddy currents can be induced in the radial part by the axial directed magnetic field, wherein conductance of the static damper element is enhanced by the axial part increasing the cross-section of the conductor, i. e. the static damper element.

In another aspect the present invention relates to a vacuum pump and in particular a molecular drag pump comprising a rotor assembly rotatably supported by one or more radial bearings and comprising a magnetic assembly as described before for axial support of the rotor and damping of rotor motion, i. e. non-axial rotation of the rotor and vibration. Therein, by the magnetic assembly an active axial bearing as well as an ECD is implemented sharing at least one rotated magnet to reduce the required building space and the number of necessary parts. Thus, at the same time costs of the vacuum pump and complexity can be reduced.

Preferably, the vacuum pump is a turbomolecular pump, a Holweck pump, a Siegbahn pump, a Gaede pump or the like.

Preferably, at least one of the one or more radial bearings is built as a passive magnetic bearing, wherein another radial bearing may be built as a roller bearing or also as a passive magnetic bearing.

Preferably, the first rotated magnet and the rotated yoke and in particular also the second rotated magnet are arranged in a common recess of the rotor. Thus, the first rotated magnet and/or the second rotated magnet as well as the rotated yoke may be fitted onto the rotor to be arranged in the common recess.

Preferably, the first rotated magnet and/or the second rotated magnet as well as the rotated yoke are fixed onto the rotor by a fastening element such as a nut preferably fixed to the end of the rotor.

Preferably, the vacuum pump comprises an axial position sensor detecting the axial position of the rotor. In particular, a surface of the fastening element is used as a detecting surface by the axial position sensor, wherein by the axial position sensor the magnetic field generated by the static coil might be controlled to maintain the axial position of the rotor.

In another aspect of the present invention a method for assembly of a vacuum pump is provided. Therein, the method comprises the steps of:
Providing a housing element;
Providing a rotor and inserting the rotor at least partially into the housing element;
Mounting subsequently a first rotated magnet onto the rotor, a static damper element to the housing element, a rotated yoke to the rotor, a static yoke to the housing and a static coil to the housing to create a magnetic assembly as aforementioned.

Thus, interlocking elements of the magnetic assembly can be easily assembled within the vacuum pump itself by a subsequent assembly of the individual parts of the magnetic assembly. It is not necessary to provide a completely preassembled rotor assembly, which is inserted into the housing or the housing element. Instead, a partially preassembled rotor assembly is inserted into the housing element and subsequently the magnetic assembly is put together in the housing element after inserting of the rotor. Therein, the housing element may be the housing of the vacuum pump or only a part of the housing of the vacuum pump. Therein, the housing element may contain one or more components of the vacuum pump such as the electromotor or the like. Alternatively, the housing element only contains the magnetic assembly and may be connected to other housing elements, which carry the electromotor or the stator of the vacuum pump.

Preferably, a first part of the static yoke, the rotated yoke, the first rotated magnet, the damper element and a second rotated magnet are assembled in this order. Thereby, interlocking elements such as the damper element and the first rotated magnet as well as the second rotated magnet can be achieved. Subsequently, the second part of the static yoke may be assembled in order to create the static yoke surrounding the actuator coil. Therein, the actuator coil can be implemented in between the aforementioned steps and may be assembled for example independently of the rotated yoke, the first rotated magnet, the damper element and/or the second rotated magnet.

Preferably, a first part of the static yoke, the first rotated magnet, the damper element, a second rotated magnet and the rotated yoke are assembled in this order.

Preferably, a first part of the static yoke, the damper element, the first rotated magnet and the rotated yoke are assembled in this order.

Preferably, a first part of the static yoke, the rotated yoke, the first rotated magnet and the damper element are assembled in this order.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with reference to the accompanying figures.

The figures show:

FIG. 1 a vacuum pump according to the present invention,

FIG. 2 a detailed view of the vacuum pump of FIG. 1,

FIG. 3 an alternative embodiment of the present invention,

FIG. 4 an alternative embodiment of the present invention and

FIG. 5 an alternative embodiment of the present invention.

### DETAILED DESCRIPTION

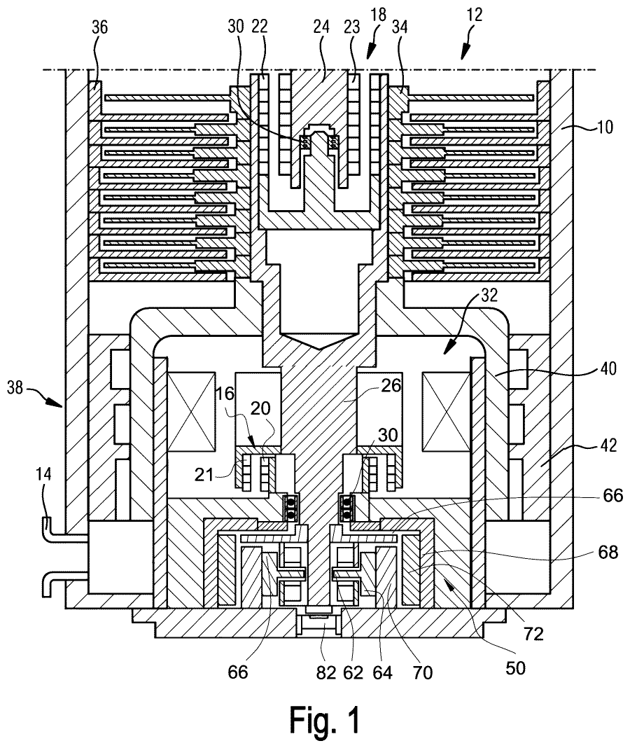

FIG. 1 shows a vacuum pump, which in this embodiment is a turbomolecular pump. The vacuum pump comprises a housing 10 including an inlet 12 and an outlet 14. A rotor 26 is disposed in the housing 10 and supported by a first radial bearing 18 built as a permanent magnetic bearing, and a second radial bearing 16 also built as a permanent magnetic bearing. The first radial bearing 18 comprises a plurality of magnet rings 22, 23 provided by permanent magnets. Therein, the static magnet rings 23 of the first radial bearing 18 are attached to a trunnion 24 extending into a recess of the rotor 26. The rotated magnet rings 22 are arranged at the inner surface of the recess radially next to the static magnet rings 23. For the second radial bearing 16 the rotated magnet rings 21 are attached in a recess of the rotor 26 radially next to the static magnet rings 20 connected to the housing. Therein, the static magnet rings 23 of the first radial bearing 18 are in mutual repulsion to each of the rotated magnet rings 22 of the first radial bearing 18, similar, the static magnet rings 20 of the second radial bearing 16 are in mutual repulsion to each of the rotated magnet rings 21 of the second radial bearing 16, respectively, thereby providing radial support of the rotor 26 within the housing 10.

Further, the first radial bearing 18 and the second radial bearing 16 comprise emergency running bearings 30 built as ball bearings. The rotor shaft 26 is driven by electromotor 32. Attached to the rotor shaft 16 are a plurality of pump elements 34 built as vanes interacting with stator elements 36 connected to the housing 10 of the vacuum pump and arranged in an alternating order with the pump elements 34. In addition, the vacuum pump of FIG. 1 comprises a Holweck stage 38 comprising a rotating cylinder 40 interacting with a threaded stator 42 connected to the housing. By rotating of the rotor shaft 26 a gaseous medium is conveyed from the inlet 12 of the vacuum pump towards the outlet 14.

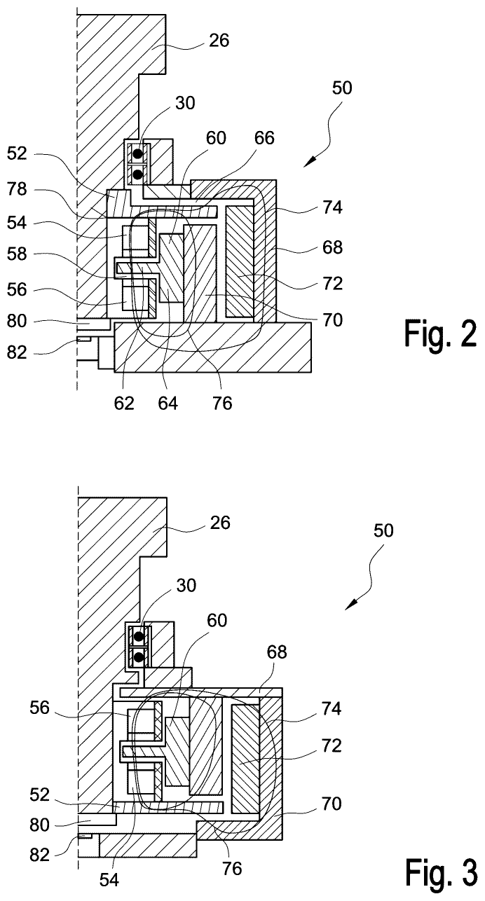

Referring now to the lower part of the rotor 26 shown in FIG. 1, FIG. 2 shows magnetic assembly 50 in more detail.

Here and in the following description the “axial direction” coincides with the rotational axis of the vacuum pump, and the radial direction is perpendicular to the axial direction. Further, same or similar elements are indicated by the same reference numbers.

The magnetic assembly 50 comprises a rotated yoke 52 connected to the rotor shaft 26, a first rotated magnet 54 and a second rotated magnet 56 both connected to the rotor shaft 26. The first rotated magnet 54 and the second rotated magnet 56 may have an axial magnetization, wherein preferably the magnetization of the first rotated magnet 54 and the second rotated magnet are identical, i.e. extending in the same direction. In-between the first rotated magnet 54 and the second rotated magnet 56 a gap 58 is created, wherein a static damper element 60 is arranged in the gap 58. Therein, the static damper element 60 in the embodiment of FIG. 2 has a T-shaped structure comprising a radial extending part 62 extending into the gap 58, and an axial extending part 64, extending in the axial direction and arranged radially of the first rotated magnet 54 and the second rotated magnet 56. The static damper element 60 is built from a conductive material such as copper. By the first rotated magnet 54, the second rotated magnet 56, acting both combinedly as damper magnets, and the static damper element 60 an eddy current damper (ECD) is provided, wherein eddy currents are induced into the static damper element 60 by the first rotated magnet 54 and the second rotated magnet 56, which then counteract unwanted movement of the rotor shaft 26 in order to suppress precession, tumbling and/or vibrations of the rotor shaft 26. Therein, the first rotated magnet 54 and the second rotated magnet 56 are built as permanent magnets having a ring shape surrounding the rotor shaft 26.

Further, by the magnetic assembly 50 an active axial bearing is implemented. The rotated yoke 52 is extending radially into a gap 66 created by a first static yoke element 68 and a second static yoke element 70. By the first static yoke element 68 and the second static yoke element 70 a static yoke is created surrounding a static coil 72. By the static coil 72 a magnetic field is created and applied via the first static yoke element 68 and the second static yoke element 70 to the rotated yoke 52. Therein, the rotated yoke 52 is arranged directly next to the first rotated magnet 54 on a side opposite to the static damper element 60. Thus, by the first rotated magnet 54 and the second rotated magnet 56 a magnetization is induced into the rotated yoke 52 which is made from a magnetic material. Thus, the first rotated magnetic 54 and second rotated magnet combinedly act as bias magnets for the axial bearing. The induced magnetization of the rotated yoke 52 is interacting with the magnetic field created by the static coil 72. Thus, by the combination of the first rotated magnet 54 as bias magnet and the static coil 72, control of the axial position of the rotor shaft 26 can be achieved.

By the static yoke 68,70 and the static coil 72 as well as the rotated yoke 52, the first rotated magnet 54 and the second rotated magnet 56, magnetic circuits 74, 76 are generated indicated in FIG. 2.

Therein, due to implementing the first rotated magnet 54 as bias magnet only a single static coil is necessary, thereby reducing the required building space and the complexity of the system. In addition, the first rotated magnet 54 simultaneously acts as bias magnet for the axial bearing as well as magnet for the ECD created together with the static damper element 60. Thus, by combination of the damper and the axial bearing, one permanent magnet can be omitted, and the related costs can be prevented. At the same time the required building space can be reduced.

As shown in FIG. 2 the magnetic assembly comprises interlocking elements such as the static yoke built by the first static yoke element 68 and the second static yoke element 70 as well as the rotated yoke 52 and, similar, the first rotated magnet 54, the second rotated magnet 56 and the radial part 62 of the static damper element 60. In order to be able to assemble such interlocking elements, the respective parts of the magnetic assembly can be mounted subsequently. Therefore, the rotor shaft 26 comprises a recess 78 to receive the rotated yoke 52, the first rotated magnet 54 as well as the second rotated magnet 56. Thus, the rotated yoke 52, the first rotated magnet 54 and the second rotated magnet 56 can be sleeved over the end of the rotor shaft 26 to be placed in the recess 68 of the rotor shaft 26. These parts can be fixed in their position by a fastening element 80, which can be built as nut or screw, which is fastened to the axial end of the rotor shaft 26. Thus, assembly of the embodiment of FIG. 2 can be performed by first inserting the first static yoke element 68 together for example with the static coil 72. Subsequently, the rotated yoke 52 is put over the axial end of the rotor shaft 26 and placed in the common recess 78 of the rotor shaft 26. Subsequently, the first rotated magnet 54 is placed in the recess 78 followed by the static damper element 60 and the second rotated magnet 56. Then, all elements arranged in the recess 78 of the rotor shaft 26 are fixed in their position by a fastening element 80. In a last step the second static yoke element 70 can be assembled. Of course, the present invention is not limited to the specific order of assembly and further parts can be assembled in a different order. For example, the second static yoke element 70 can be assembled together with the static damper 60. Also, the static coil 72 can be assembled after assembly of the rotated yoke 52 and/or first rotated magnet 54.

The magnetic assembly further comprises an axial position sensor 82, wherein by the axial position sensor 82 the axial position of the rotor shaft 26 is detected. Therein, the axial position sensor 82 may use the axial end surface of the fastening element 80 as a reference surface in order to detect the axial position of the rotor shaft 26.

FIG. 3 shows another embodiment of the magnetic assembly 50. Therein, the position of the first rotated magnet 54 and the second rotated magnet 56 in the axial direction are switched compared to the embodiment of FIG. 2. Consequently, the rotated yoke 52 is arranged at the axial end of the rotor shaft 26. Similarly, the order of assembly changes in that the first static yoke element 68 is assembled followed by the second rotated magnet 56 and the static damper element 60. Subsequently, the first rotated magnet 54 and the rotated yoke 52 are assembled fixed by the fastening element 80. Finally, the second static yoke element 70 is assembled together with the static coil 72.

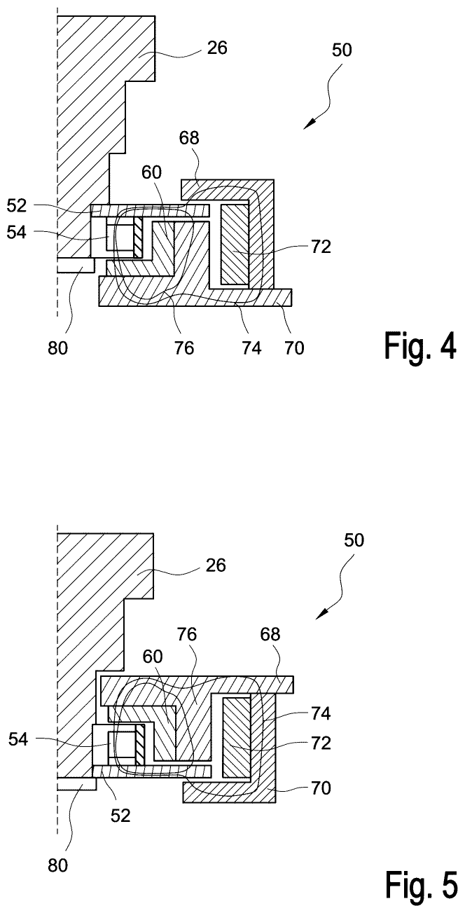

FIG. 4 shows a magnetic assembly 50 comprising only the first rotated magnet 54. In this case the static damper element 60 is L-shaped. For the assembly first the first static yoke 68 is assembled. Subsequently, the rotated yoke 52 followed by the first rotated magnet 54 are assembled to the rotor shaft 26. Subsequently, the static damper element 60 together with the second static yoke element 70 is assembled.

FIG. 5 shows a reversed arrangement of the magnetic assembly 50 compared to the embodiment of FIG. 4. For the assembly first the first static yoke element 68 is assembled together with the static damper element 60. Subsequently, the first rotated magnet 54 and the rotated yoke 52 are assembled to the rotor shaft 26 and may be fixed by fastening element 80 in their position. Subsequently, the second static yoke element 70 together with the static coil 72 is assembled.

Thus, by the present invention a combination of an active axial bearing together with an eddy current damper is provided. Thereby, the number of necessary magnets is reduced, thereby reducing the required building space and the costs. Therein, at least one permanent magnet of the magnet assembly according to the present invention simultaneously acts as bias magnet for the active magnetic axial bearing and damper magnet of the eddy current damper.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A magnetic assembly for a rotor preferably of a molecular drag vacuum pump, comprising
a first rotated magnet to be connected to the rotor and rotated together with the rotor,
a static damper element arranged axially next to the first rotated magnet, acting as a damper magnet to induce eddy currents into the static damper element,
a rotated yoke extending radially and arranged axially next to the first rotated magnet,
a static coil configured to generate a magnetic field, and
a static yoke connected to the static coil and arranged directly next to the rotated yoke to induce an axial magnetic force into the rotated yoke such that the first rotated magnet at the same time acts as a bias magnet.

2. The magnetic assembly according to claim 1, wherein the static yoke surrounds the static coil and comprises a gap, wherein the rotated yoke extends into the gap.

3. The magnetic assembly according to claim 1, wherein the rotated yoke and/or the static yoke are made from a magnetic material.

4. The magnetic assembly according to claim 1, wherein the static damper element is made of a conductive material.

5. The magnetic assembly according to 1-wherein the first rotated magnet comprises a first axial end and an opposite second axial end, wherein the static damper element is arranged directly axially next to the first axial end and the rotated yoke is connected to the second axial end.

6. The magnetic assembly according to claim 1, comprising a second rotated magnet.

7. The magnetic assembly according to claim 6, wherein the second rotated magnet is arranged axially next to the first rotated magnet in a distance to create a gap in-between, wherein preferably the static damper element extends into the gap between the first rotated magnet and the second rotated magnet.

8. The magnetic assembly according to claim 1, wherein the damper element is L-shaped or T-shaped comprising an axial part extending in an axial direction, wherein the axial part is radially next to the first rotated magnet and/or the second rotated magnet, and a radial part extending in a radial direction, wherein the radial part is arranged axially next to the first rotated magnet and/or the second rotated magnet.

9. A vacuum pump comprising a rotor assembly rotatably supported by one or more radial bearings and comprising a magnetic assembly according to claim 1 for axial support and damping.

10. A method for assembly of a vacuum pump comprising the steps of:
Providing a housing element;
Providing a rotor and inserting the rotor at least partially into the housing element;
Mounting subsequently a first rotated magnet onto the rotor, a static damper element to the housing element, a rotated yoke to the rotor, a static yoke to the housing and a static coil to the housing to create a magnetic assembly according to claim 1.

11. The method according to claim 10, wherein a first part of the static yoke, the rotated yoke, the first rotated magnet, the damper element and a second rotated magnet are assembled in this order.

12. The method according to claim 10, wherein a first part of the static yoke, the first rotated magnet, the damper element, a second rotated magnet and the rotated yoke are assembled in this order.

13. The method according to claim 10, wherein a first part of the static yoke, the damper element, the first rotated magnet and the rotated yoke are assembled in this order.

14. The method according to claim 10, wherein a first part of the static yoke, the rotated yoke, the first rotated magnet and the damper element are assembled in this order.
